(19) United States
(12) Patent Application Publication
(10) Pub. No.: US 2013/0262245 A1
(43) Pub. Date: Oct. 3, 2013

(54) DIGITAL EMULATION OF CASH-BASED TRANSACTIONS

(71) Applicants: Shankar Narayanan, Singapore (SG); Tsu Hua Michael Wee, Sarawak (MY)

(72) Inventors: Shankar Narayanan, Singapore (SG); Tsu Hua Michael Wee, Sarawak (MY)

(21) Appl. No.: 13/724,705

(22) Filed: Dec. 21, 2012

(30) Foreign Application Priority Data
Mar. 27, 2012 (AU) 2012901214

(51) Int. Cl. G06Q 40/00

(52) U.S. Cl. CPC G06Q 40/00
USPC 705/14.73; 705/35

(57) ABSTRACT

A method for digital emulation of cash-based transactions wherein upon a server receiving a request for digital currency for a nominated amount, the server generates and sends a unique link, the unique link comprising one of: a short URL, URL, unique web address, and unique identifier; and wherein the unique link has attached to it at least one selected from the group comprising: image(s), picture(s), video, audio, document(s), advertisement(s), check-in functionality, geo-tag location(s), and metadata.

### TECHNICAL FIELD

This invention relates to the digital emulation of cash-based transactions and refers particularly, though not exclusively, to a method of associating a unique link to detailed encrypted data contained in a database for a credit card, debit card, pre-paid card, a currency denomination; or a payment transaction involving one or more of them. By unique link is meant a short URL, URL or unique web address or unique identifier. Preferably, the unique link has attached to it at least one of: image(s), picture(s), video, audio, document(s), advertisement(s), check-in functionality, geo-tag location(s), and metadata to enable the attachment of emoticons.

### BACKGROUND

Paper currency was first developed in China in the Tang Dynasty during the 7th century, and was later introduced in the Mongol Empire, Europe, and America. The first European banknotes were issued by Stockholm Banco, a predecessor of the Bank of Sweden, in 1661. Bank notes in each country now carry an identifying code that is unique to that bank note in that country. For example, an Australian $50 bank note may have the identifying code JM 09044102. No other bank note in Australia will have that identifying code.

On-line and mobile commerce is now normal. In 2009, there were 56.4 billion credit, debit and prepaid card transactions, totaling 3.39 trillion dollars in the US alone. (Nielson Report, February 2010.). On-line and digital commerce is likely to grow substantially in the coming years.

Presently online commerce is conducted using payment instruments such as credit-cards, debit-cards and pre-paid cards utilising payment gateways services. But it does not emulate the fluidity of cash in the digital domain. Credit cards, debit cards and pre-paid crads require much information to be widely circulated and stored. That information my include, for example, the credit card number as well as the currency and value of the transaction. That can lead to security issues

### SUMMARY

Disclosed is a method using one-time transaction information of cash or a credit card, debit card or direct internet banking transaction and embedding a unique one-time use URL, short URL or web address (“unique link”)for cash, credit card, debit card, internet banking transactions.

The unique link has attached to it at least one of: image(s), picture(s), video, audio, document(s), advertisement(s), check-in functionality, geo-tag location(s), and metadata to enable the attachment of emoticons.

### BRIEF DESCRIPTION OF THE DRAWINGS

In order for the invention to be fully understood and readily put into practical effect, there shall now be described by way of non-limitative example only an exemplary embodiment of the present invention, the description being with reference to the accompanying illustrative drawings.

In the drawings:

FIG. 1 is an illustration using an image of a known US$100 banknote showing its unique identifying code and how that is used;

FIG. 2 is an illustration similar to that of FIG. 1 but where a credit card, debit card or pre-paid card is used;

FIG. 3 is an illustration of a known credit card process;

FIG. 4 is an illustration similar to that of FIG. 3 but using an exemplary method of the present invention;

FIG. 5 is a flow chart illustrating the use of an ATM for digital cash creation;

FIG. 6 is a flow chart similar to FIG. 5 of the use of digital currency for a transaction with a merchant;

FIG. 7 is a flow chart similar to FIGS. 5 and 6 of the use of digital cash for a peer-to-peer transaction;

FIG. 8 is a flow chart similar to FIGS. 5 to 7 of the use of digital cash for a peer-to-peer transaction with direct debit;

FIG. 9 is a flow chart similar to FIGS. 5 to 8 of the use of digital cash for a peer-to-peer transaction with direct bank debit;

FIG. 10 is an illustration of the addition of metadata to the unique link;

FIG. 11(a) is an illustration of the addition to the unique link of an advertisement containing a functional view; and

FIG. 11(b) is an illustration of the addition to the unique link of an advertisement containing a schematic view.

### DETAILED DESCRIPTION OF EXEMPLARY EMBODIMENTS

Throughout the description, and in the drawings, like components are given like reference numerals with a prefix number indicating the drawing figure number.

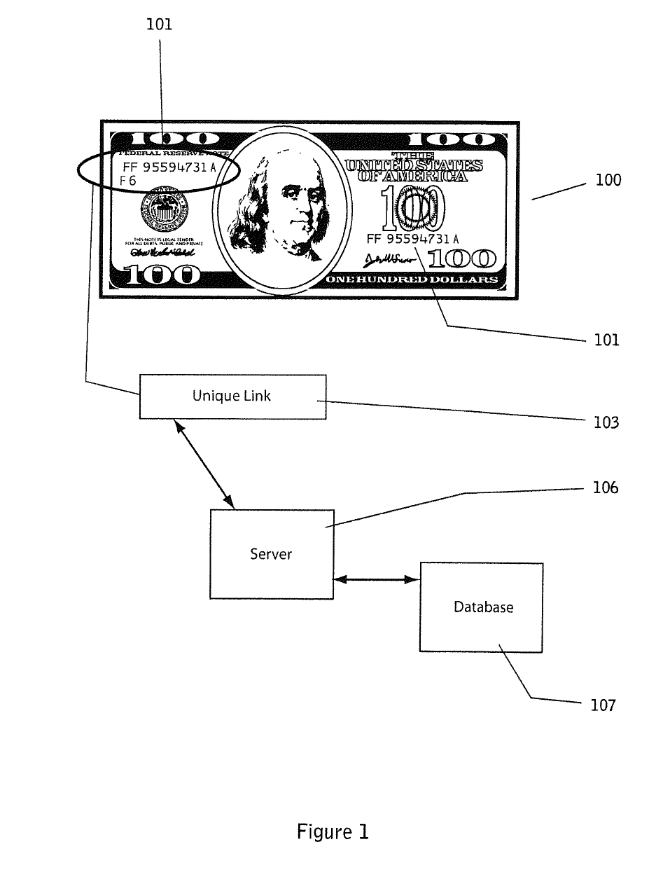

As shown in FIG. 1, a bank note 100 has the unique identifying code or serial number AE 77665544B designated as 101 on the drawing. That code is unique to that bank note as issued by the government of the USA. There may be bank notes in other countries that have the same unique identifying code, but in USA there can be no other. By using or converting the identifying code or serial number 101 to a short URL, URL or unique web address (“unique link”)103, or having the serial number 101 in the form of a unique link 103, it is possible to have the bank note in the digital domain using a secure server 106 with currency, each item of currency having a unique link 103. The server 106 is operatively connected to a secure database 107 of the digital currency 103. Typically this will be with or controlled by the monitory authority of each country and the digital currency will be issued to banks, which then can use the digital currency. The identifying code may be related to that of an actual, physical bank note, or may be an artificially created code representing the serial number of a bank note for that denomination in that country, if one were to be physically created. The issuing authority in the country concerned may reserve a series of serial numbers of bank notes of a particular denomination in actual, physical circulation, and a different series of serial numbers of digital currency in circulation in the digital domain. The serial numbers of digital currency may be randomly generated.

The proposed method emulates the true method and value of cash-based transactions in the digital domain by associating a unique link 103 linking to detailed encrypted data contained in the database 107 for a payment transaction or a currency denomination. The unique link 103 preferably includes the domain of the country concerned to ensure uniqueness. Given the US$100 banknote of FIG. 1, the unique web link may be: www.domainname.com/ae77665544b—the domain for USA preferably not requiring a geographic code whereas that for another country may require the geographic code. For example, the Australian $50 bank note referred to above may have the unique link: www.domainname.com.au/jm09044102 whereas that of a credit card numbered 4567 8901 2345 6789 may be www.domainname.com/4567890123456789. The domainname in each instance would be a domain name of the relevant issuing authority, card company, secure server 106 or otherwise as required or desired.

This allows for the creation of unique digital authentication by creating a unique link for every transaction and every currency denomination. This will enable secure on-line or mobile payment transactions using digitized cash. In particular, but not exclusively, the method enables details of transactions for payment or funds transfer by the system creating a unique link 103 for the specific transaction. This unique link 103 behaves like cash in the real world and can be freely transmitted using social media instruments on the Internet. The serial numbers of digital currency may be visible (as shown), invisible, or embedded such as in a chip.

The unique link 103 may be secured by any known technique. For example, a password and/or PIN code may be used in conjunction with the unique link 103. In addition, or alternatively, the unique link 103 may be encrypted. SSL and/or HTTPS may also be used. Preferably, no compression is used. However, if compression is used it is preferably lossless.

The unique link 103 preferably follows the monetary authority's currency denomination. This allows for the 106 server to create unique links 103 based on any denomination of the digital currency.

For all transactions, if the user is using a mobile telephone or telecommunications enabled apparatus (e.g. tablet computer) the database 107 may capture location-based information from a user's mobile ‘phone or telecommunications enabled apparatus whilst creating the unique link 103. In the case of a transaction involving digital currency, whenever it is created or a unique link 103 is forwarded via social media or any channel, location information and other critical data may be captured for data analytics.

Due to the unique link 103 on the printed currency or digital currency, the monetary authority can obtain data on the movement of money from the database 107.

Making a payment is one step process: DRAG and DROP and the payment is made.

When a payment is made to third party via the uniquelink, the method can be anonymous like cash in the real world, or it can be tracked in the server 106. The data is processed and a unique one-time digitally-signed link 103 is created for the user to pay for goods and services. The unique link 103 may comprise one or more currency values such as, for example,
www.domainname.com.au/jm09044102
for the AU$50 note referred to above, or
www.domainname.com.au/jm09044102/gi96729220
for the AU$50 note referred to above plus an AU$100 note GI96729220 for a transaction totaling AU$150.

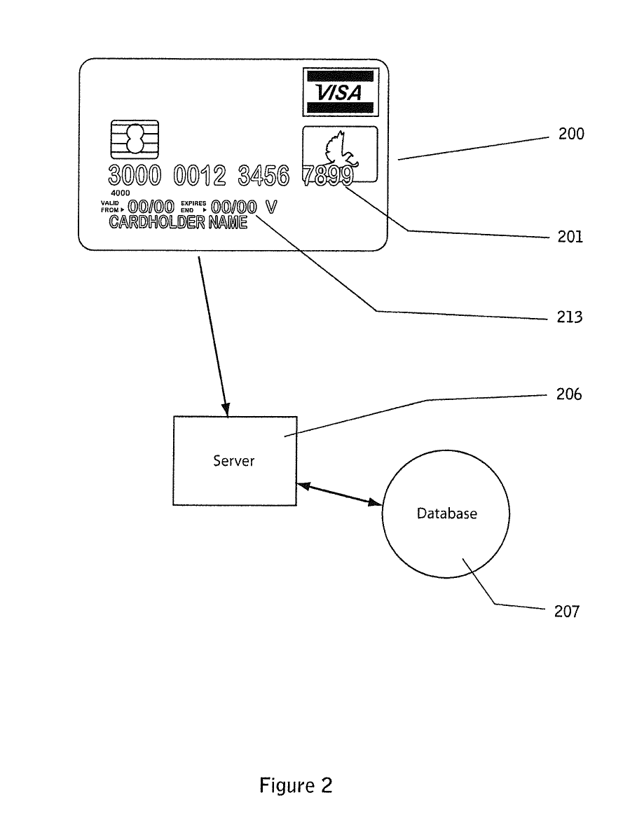

FIG. 2 illustrates the process when a card such as a credit card, debit card or pre-paid card 200 is used. The credit card number 201, identity of the payee/receiver, and one or more of: CVV (on the rear of the card 200 and not shown), expiry date 213, amount of the total transaction, an image of the card 200, and GPS location, are processed by the server 206 and a one-time, unique link is created by the server 206 for the user of card 200 to pay for goods or services, or other form of transaction, the data being stored in the database 207.

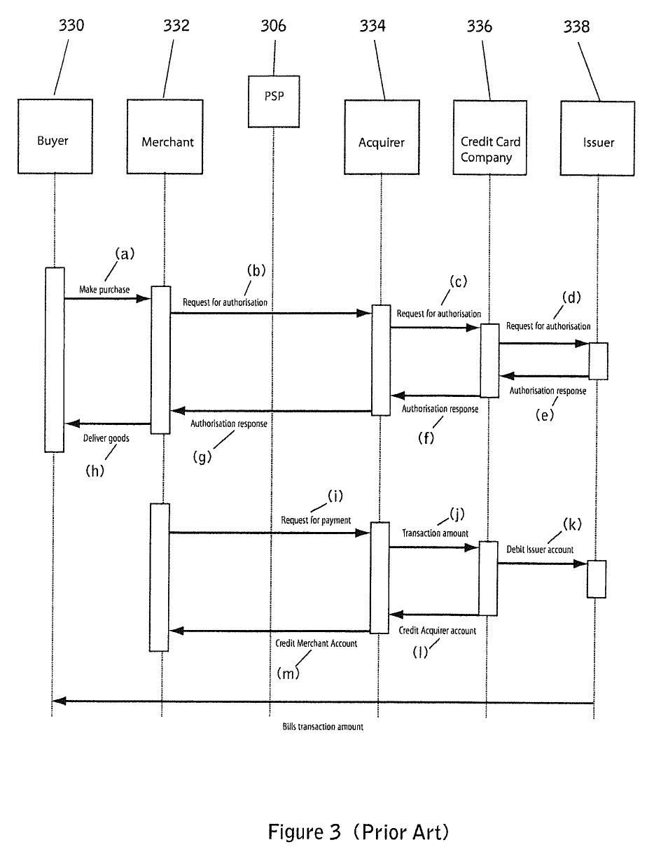

In FIG. 3 is shown a known, prior art credit card transaction process. As can be seen the process flow is:
(a) the buyer 330 makes a purchase at a merchant 332;
(b) the merchant uses their point-of-sale terminal and the credit card of the buyer 300 to request authorization from the merchant's bank computer system 334;
(c) the merchant's bank legacy computer system 334 requests authorization from the credit card company computer system 336;
(d) the credit card company computer system 336 requests authorization from the computer system 338 of the bank of the buyer 300;
(e) the computer system 338 of the bank of the buyer approves the purchase to the computer system 336 of the credit card company;
(f) the computer system 336 of the credit card company approves the purchase to the merchant's bank computer system 334;
(g) the merchant's bank computer system 334 approves the purchase to the point-of-sale terminal 332 of the merchant;
(h) the merchant delivers the goods to the customer;
(i) the merchant's point-of-sale terminal 332 then makes a request to the computer system 334 of the bank of the merchant for the amount to be credited to the merchant's account;
(j) the computer system 334 of the bank of the merchant requests the transaction amount from the computer system 336 of the credit card company;
(k) the computer system 336 of the credit card company debits the account of the buyer 300 at the computer system 338 of the bank of the buyer 300 and remits the funds to the computer system 336 of the credit card company; and
(l) the computer system 336 of the credit card company then credits the account of the merchant at the computer system 334 of the bank of the merchant.

This involves two banks, at least one credit card system (there may be more than one if the buyer's credit card office is in a different country to the merchant) and thirteen transaction steps.

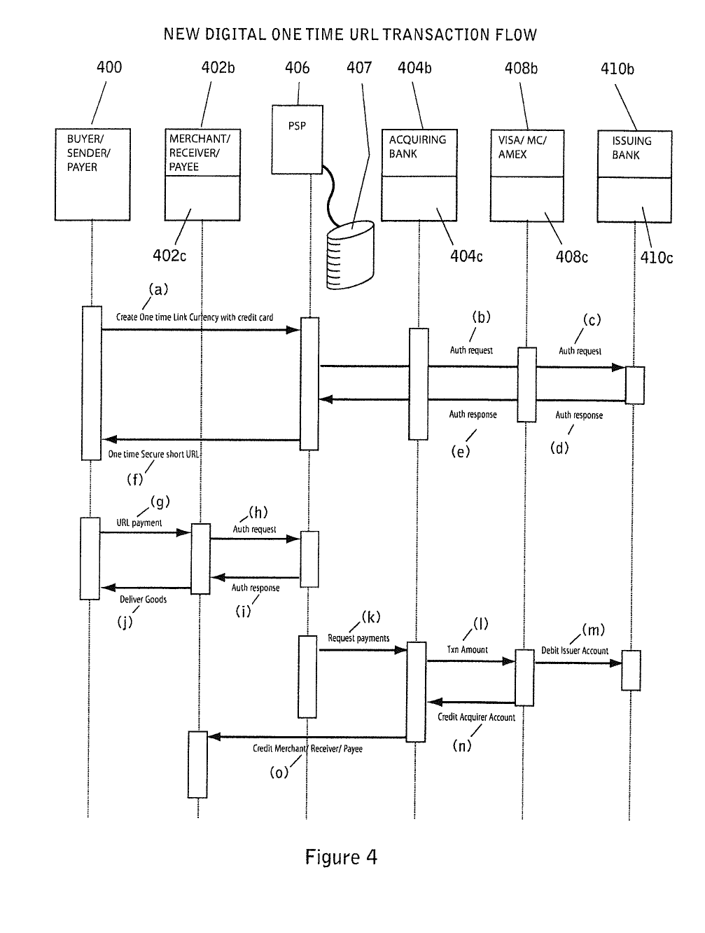

The exemplary embodiment of FIG. 4 involves an Internet-enabled apparatus 400 of a buyer, a POS terminal 402c of a merchant 402b, the secure server 406, the computer system 404c of the bank 404b of the merchant 402b, the computer system 408c of the credit card company 408b, and the computer system 410c of the bank 410b of the buyer. The apparatus 400 may be any suitable telecommunications-enabled device, preferably Internet enabled, such as, for example, laptop computer, desktop computer, personal computer, notebook computer, tablet computer, or cellular/mobile telephone such as a smart ‘phone. This creates a system divided into zones with each zone being separated from the other zones, and being accessible by other zones only through firewalls and after authentication.

The exemplary process illustrated is:
(a) the apparatus 400 is used to send a request to the server 406 for digital cash of a given value with a unique link. This may be using a bank account (as per FIG. 1) or credit/debit/pre-paid card (as per FIG. 2);
(b) the server 406 requests authorisation from the issuing bank 410b computer system 410c. This may be direct for a bank-issued card, or
(c) via the credit credit card company 408b computer system 408c;
(d) the authorisation response is sent from the issuing bank 410 computer system 410c to the server 406. This may be direct for a bank-issued card, or
(e) via the credit credit card company 408b computer system 408c;
(f) the server 406 generates the unique link for the given value and provides it to the apparatus 400;
(g) the apparatus 400 provides the unique link to the merchant 402b POS terminal 402c, which then
(h) issues an authorisation request to the server 406;
(i) the authorisation is provided to the POS 402c by the server 406;
(j) the merchant 402b can then provide the goods to the buyer;
(k) the server 406 requests payment from the merchant bank 404b computer system 404c which then passes the request to the buyer bank 410b computer system 410c directly or
(l) via the credit card company 408b computer system 408c;
(m) the buyer's account on the computer system 410c at issuing bank 410 is debited and
(n) the credit passed to the merchant bank 404b computer system 404c; and
(o) the account of the merchant 402b at the acquiring bank 404b computer system 404c is credited and a receipt sent by the computer system 404c to the POS terminal 402c.

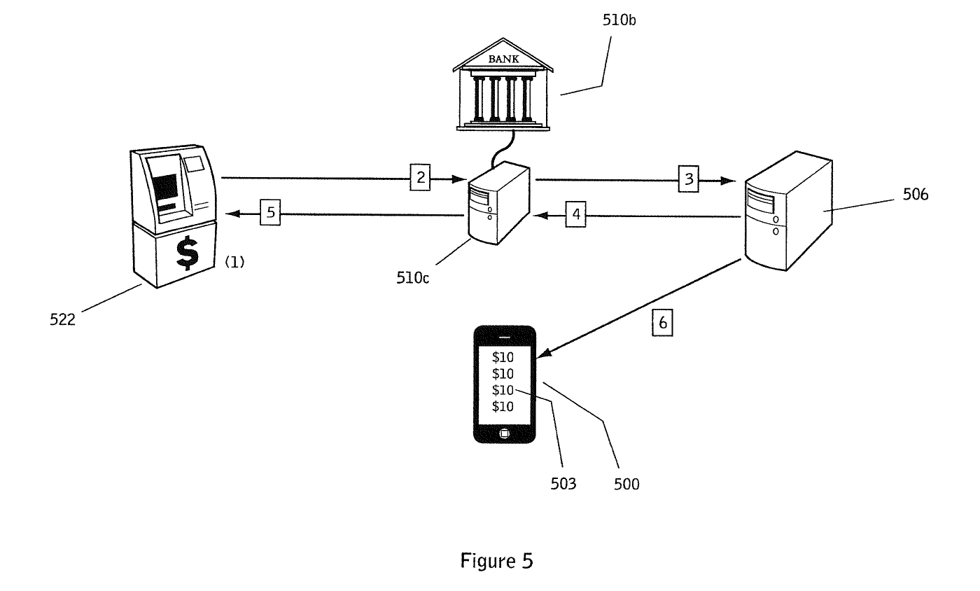

In FIG. 5 the processes of FIGS. 1 and/or 2 are used in the use of an ATM for digital cash creation rather than cash withdrawal or transfer:
(1) a bank automatic teller machine (“ATM”) 522 is used by a customer to create digital cash of a given value instead of withdrawing cash;
(2) the ATM 522 requests authorization of the transaction from the computer system 510c of the bank 510b of the ATM 522 and seeks to debit the account of the customer at the bank 510b computer system 510c;
(3) a unique link according to FIG. 1 or 2 is requested of the secure digital currency server 506 by the computer system 510c of the bank 510b;
(4) the server 506 creates the unique link for the given value and sends it to the bank 510b computer system 510c for audit purposes;
(5) approval of the transaction, with reference number, is sent to the ATM 522 by the bank 510b computer system 510c;
(6) the customer receives the unique link 503 on their apparatus 500. The apparatus 500 may be any suitable telecommunications-enabled device such as, for example, laptop computer, notebook computer, tablet computer, or cellular/mobile telephone such as a smart ‘phone (as shown). The unique link 503 is in the required denominations, preferably using a special application residing in the apparatus 500. For example, for $40 this may be four icons 503 of $10 digital bank notes each with a unique link. The apparatus 500 may have previously been registered with the bank 510b computer system 510c, as is known for issuing of authorizing codes by banks for on-line banking transactions. The unique links may be received by SMS, MMS, Wi-Fi, or otherwise as required or desired. Alternatively, the apparatus 500 may communicate with the ATM 522 by Bluetooth or similar short-range wireless technologies. The denominations of the unique links 503 may be set during (1).

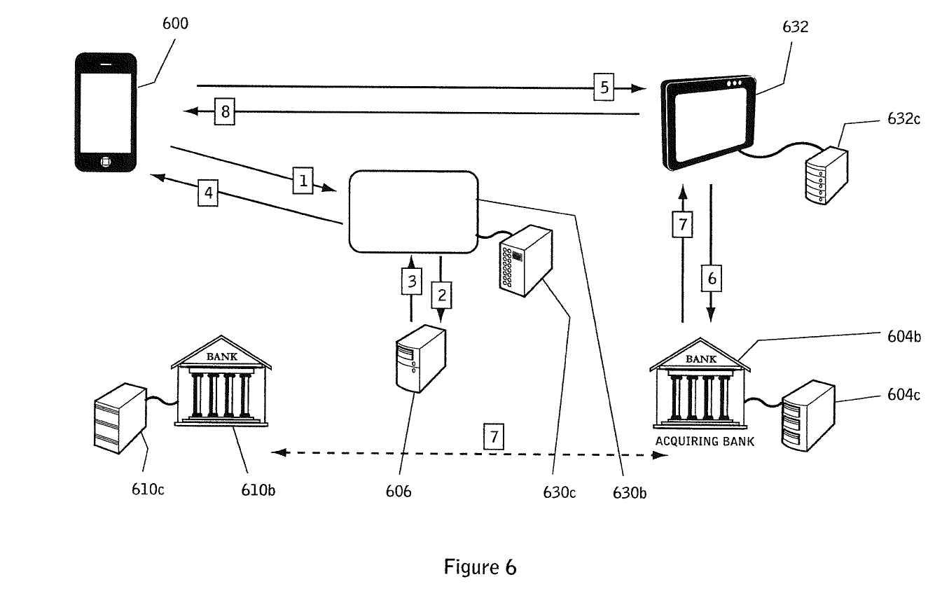

In FIG. 6 is shown the use of digital currency for a transaction with a merchant using the processes of FIGS. 1 and/or 2:
(1) using their apparatus 600 (similar to the apparatus 500 but may also include a desktop or personal computer) a user creates and the apparatus 600 sends a request for digital currency of a stated value using their card (credit, debit or pre-paid). This is to the computer system 630c of the card company 630b;
(2) the computer system 630c of the card company 630b requests the secure digital currency server 606 to create a unique link for the requested digital currency;
(3) the secure server 606 creates the unique link/digital currency and this is sent to the computer system 630c of the card company 630b;
(4) the computer system 630c of the card company 630b passes the unique link to the user's apparatus 600;
(5) the apparatus 600 is used for a purchase at an on-line store 632 and pays using the unique link/digital currency;
(6) the on-line store computer system 632c requests authorisation of the transaction and the debiting of the user's account from their bank 604b computer system 604c;
(7) the bank 604b computer system 604c approves the transaction and the user's bank 610b account in the computer system 610c is debited and the merchant bank 604b account on the computer system 604c credited; and
(8) transaction approval is passed to the user's apparatus 600 and the computer system 632c of the on-line store 632 arranges for delivery of the goods.

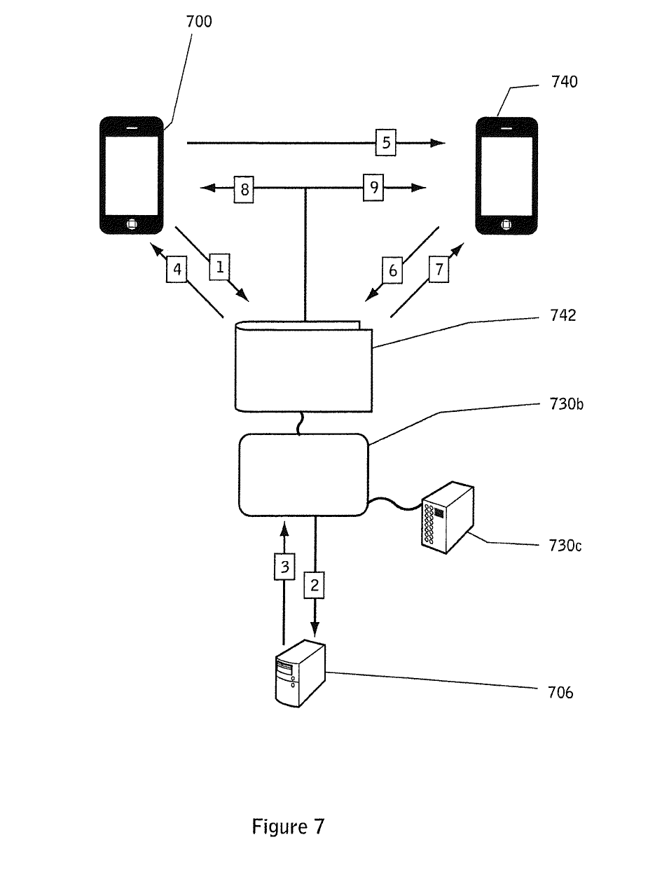

FIG. 7 shows the use of digital cash for a peer-to-peer transaction in which the processes of FIGS. 1 and/or 2 are used:
(1) using their apparatus 700 (similar to the apparatus 600) a user creates, and the apparatus 700 sends, a request for digital currency of a particular value using their card (credit, debit or pre-paid). This is to an on-line wallet 742 of the computer system 730c of the card company 730b;
(2) the computer system 730c of the card company 730b requests the secure digital currency server 706 to create a unique link/digital currency for the particular value;
(3) the secure server 706 creates the unique link/digital currency and this is sent to the computer system 730c of the card company 730b;
(4) the computer system 730c of the card company 730b passes them to the user's apparatus 700 and credits the user's on-line wallet 742;
(5) the user's apparatus 700 sends the unique link/digital currency to the apparatus 740 of a peer;
(6) the apparatus 740 of the peer requests authorisation of the transaction from the computer system 730c of the card company 730b, the debiting of the account of the user at the on-line wallet 742, and the crediting of the peer's nominated account;
(7) the computer system 730c of the card company 730b approves the transaction, debits the user's account in the on-line wallet 742 and credits the peer's nominated account;
(8) a receipt is sent by the computer system 730c of the card company 730b to the user's apparatus 700; and
(9) a receipt is sent by the computer system 730c of the card company to the peer's apparatus 740.

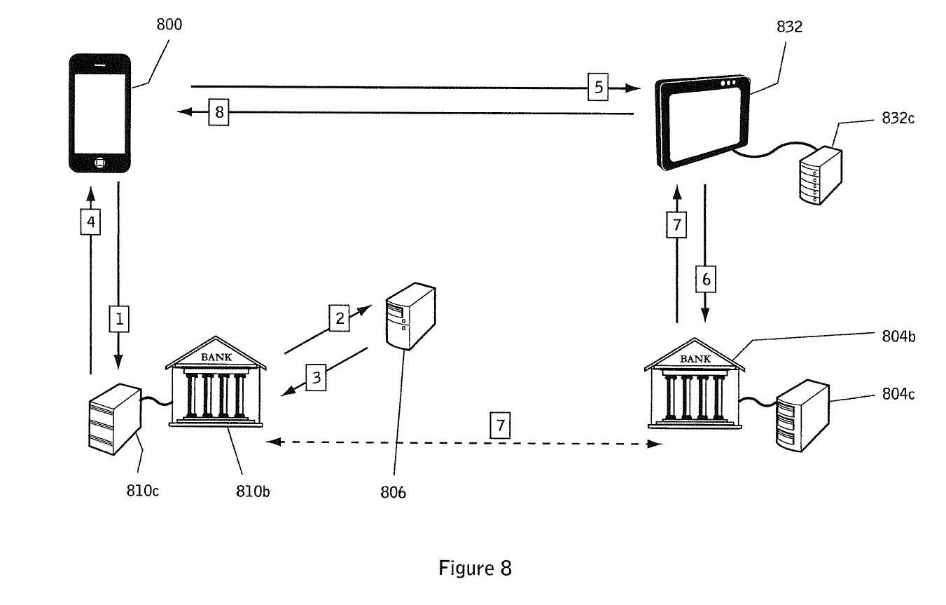

In FIG. 8 is shown the use of digital cash for a peer-to-peer transaction with direct debit in which the processes of FIGS. 1 and/or 2 are used:
(1) using their apparatus 800 (similar to the apparatus 600) a user creates, and the apparatus 800 sends, a request for digital currency of a nominated amount using their card (credit, debit or pre-paid). The request is sent directly to the computer system 810c of the bank 810b of the user;
(2) the computer system 810c of the user's bank 810b requests the secure digital currency server 806 to create a unique link/digital currency for the nominated amount;
(3) the secure server 806 creates the unique link/digital currency and this is sent to the computer system 810c of the user's bank 810b;
(4) the computer system 810c of the user's bank 810b passes them to the user's apparatus 800;
(5) the apparatus 800 is used for a purchase at an on-line store 832 and payment is by using the unique link/digital currency;
(6) the on-line store 832 computer system 832c requests authorisation of the transaction and the debiting of the user's account on computer system 810c from their bank 804b computer system 804c;
(7) the bank 804b computer system 804c approves the transaction and the user's account on computer system 810c is debited and the merchant's account on computer system 804c is credited; and
(8) transaction approval is passed to the user's apparatus 800 and the on-line store 832 arranges for delivery of the goods.

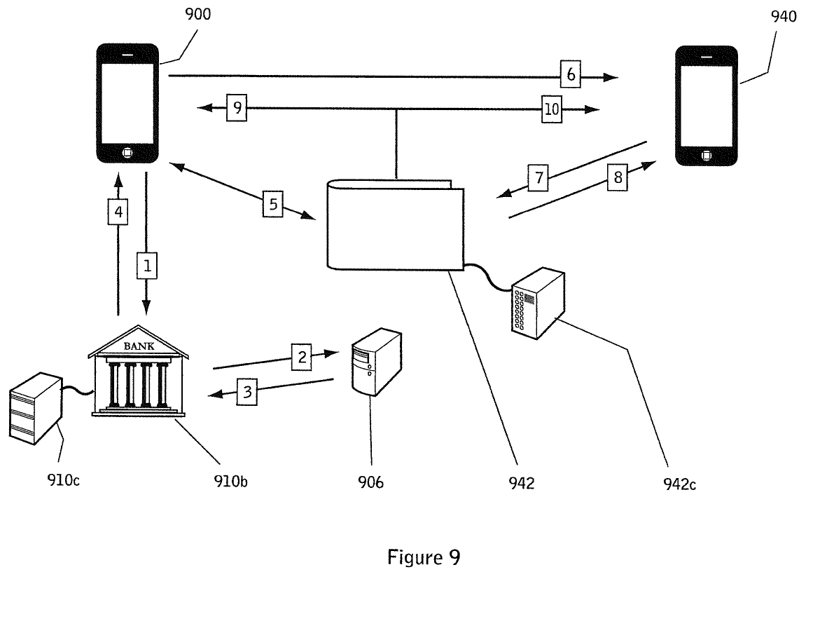

FIG. 9 illustrates the use of digital cash for a peer-to-peer transaction with direct bank debit in which the processes of FIGS. 1 and/or 2 are used:
(1) using their apparatus 900 (similar to the apparatus 600) a user creates, and the apparatus 900 sends, a request for digital currency of a nominated amount using their card (credit, debit or pre-paid). The request is sent directly to the computer system 910c of the bank 910b of the user;
(2) the computer system 910c of the user's bank 910b requests the secure digital currency server 906 to create a unique link/digital currency for the nominated amount;
(3) the secure server 906 creates the unique link/digital currency and this is sent to the computer system 910c of the user's bank 910b;
(4) the computer system 910c of the user's bank 910b passes them to the user's apparatus 900;
(5) the user's apparatus 900 is used to update the user's on-line currency wallet 942;
(6) the user's apparatus 900 is used to send the unique link/digital currency to the apparatus 940 of a peer;
(7) the apparatus 940 of the peer requests authorisation of the transaction from the user's wallet 942 and the debiting of the account of the user at the on-line wallet 942;
(8) the computer system 942c of the on-line wallet 942 approves the transaction, debits the user's account and credits the peer's account;
(9) a receipt is sent by the computer system 942c of the on-line wallet 942 to the user's apparatus 900; and
(10) a receipt is sent by the computer system 942c of the on-line wallet 942 to the peer's apparatus 940.

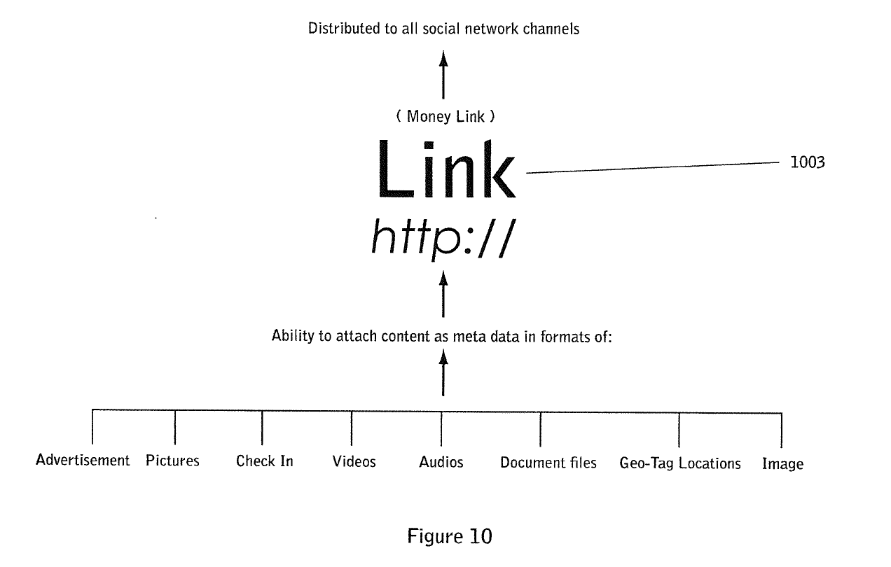

As shown in FIG. 10, the unique link 1003 may have attached to it, or also be directed to, for example, one or more of: file(s), image(s), picture(s), video, audio, document(s), advertisement(s), check-in functionality, geo-tag location(s), metadata, and emoticons. This would enable, for example, the electronic sending of a digital greeting card and digital money as a gift.

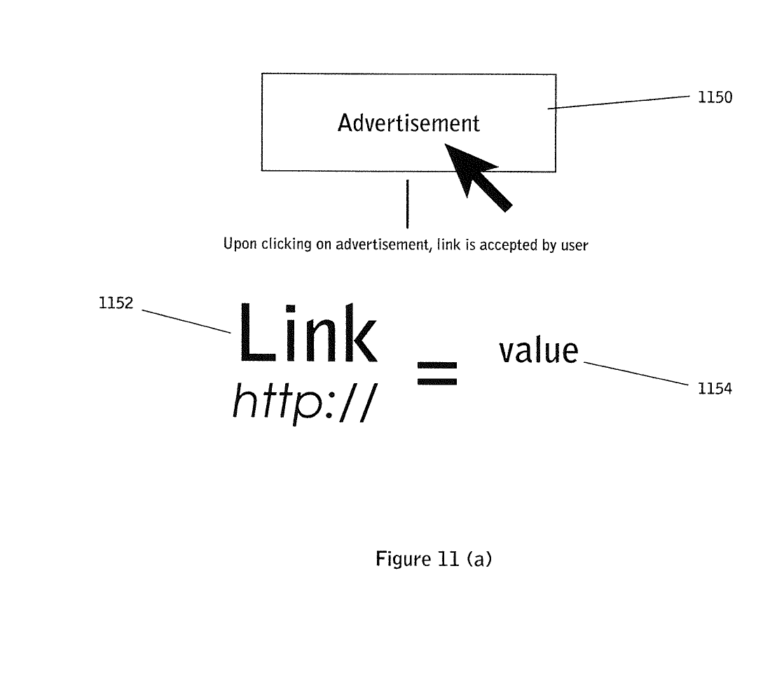

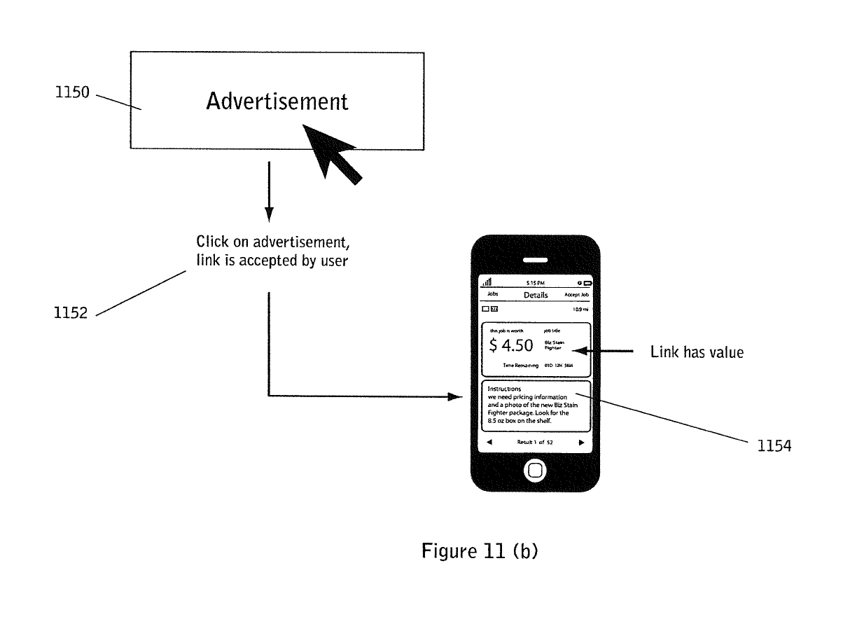

In FIGS. 11(a) and (b) is shown the case of an advertisement 1150 of FIG. 10, where the advertisement 1150 contains a further link 1152 that is accepted by a click on the advertisement 1150. The further link 1152 may also contain a value 1154 determined by the advertiser. The value may be one or more of, for example: actual currency, the advertiser's brand “currency”, a discount voucher or token, a promotion value that may be based on a percentage of the total cost; a discounted or free gift; a reimbursement that may be a voucher or token, or other forms of physical items. The further link 1152 may be mass distributed but the value may be based on the individual's account name or identifier. Furthermore, the account to where the value is credited and/or sent may also be based on the individual's account name or identifier.

In addition, conversion may also be possible so that transactions in other systems may be able to proceed in accordance with the present invention. Conversion may be possible from, for example, PayPal™, PSP, Internet banking, and mobile banking.

The advantages include one or more of:
(1) mitigating creditcard and debit card fraud;
(2) assists merchants in reducing their risks;
(3) it is a customer-initiated transaction. As the customer creates and distributes the digital currency, the control for the transaction is with the customer;
(4) digital currency in the URL form is easily transferable by social networks;
(5) it is secure, as the validity and amount is unique to the transaction. Hence no credit card or debit card numbers are distributed; and
(6) by having a short URL, URL or web address on the bank note the governmental agencies and banking authorities can maintain a digital track of the currency. This also addresses money laundering risks and the cash economy often used to avoid paying tax.

The payment process involves the entities:
(1) digital currency authority;
(2) digital currency issuer;
(3) consumer;
(4) consumer wallet; and
(5) digital currency bank.

The digital currency authority may have a Secure Certificate (PKI) that is used to sign every digital currency issuer certificate which authorises them to issue currency. They are preferably double-signed with two certificates so that the compromise of any one certificate does not compromise security. The two certificates are preferably maintained in two different locations and handled by two different teams.

The digital currency issuer also has two certificates each double-signed by the authority. It uses these to sign any digital currency.

Digital currency is preferably always issued to a known entity. The entity is identified by its identity (email, mobile, phone, Facebook identity, company registration number, business number, driver's license number, identity card, and so forth). The recipient may be required to be verified and/or may be linked to a specific medium. In addition, the recipient may be required to provide an acknowledgement of receipt of the payment to the sender.

The digital currency file or url, barcode, and so forth, may contain:
(1) value;
(2) currency code (USA, EUR, etc);
(3) issued to;
(4) serial no.;
(5) signature 1;
(6) signature 2;
(7) issuer public key certificate 1; and
(8) issuer public key certificate 2.

Any currency file can be securely validated in realtime against the issuer's servers by sending the value, currency code, issued to and serial number.

Offline Transferred Currency

Any currency file can be transferred by adding the following information to the standard fields:
(a) transferred to;
(b) owner's signature with his device wallet specific private key;
(c) owner device signature certificate which is double-signed by the digital currency authority; and
(d) value of the currency transferred (to support partial transfers when exact change is not available).

This offline transferred currency can be transferred once again to any other entity. This may be by appending a, b, or c above.

Upon first connection to the server, the transferred currency file may be converted to a currency that is issued directly to the new recipient.

Offline Payment Fraud

If the user transfers the same currency twice to two individuals (by restoring backup files, etc) it is fraud and it should be collected from the users by deducing from his account balance or by other means.

Bank

Users can transfer currency from a device to and from the bank for safekeeping. The bank can be an existing bank account in a brick and mortar bank that supports digital currency, or it can be a virtual online digital currency bank.

A digital currency debit card may be a traditional-looking card that is linked to the bank account and can be used to make payments.

Online payments can be made by direct debit from the bank.

Currency splits and joins can be done so that the exact change for a payment can be obtained. A $100 currency note can be exchanged for $50, $20, $10, $5, $2, $1 notes in all possible permutations and combinations to achieve the required total of $100.

Unique links 103 may be used for payments between, by or to one or more of:
governments;
monetary authorities;
merchants;
traders;
advertisers;
brand owners;
e-wallets;
payment service providers;
banks;
financial institutions;
mobile money service providers;
global funds transfer providers; and
remittance hubs.

Whilst there has been described in the foregoing description exemplary embodiments of the present invention, it will be understood by those skilled in the technology that many variations or modifications in details of design, construction and/or operation may be made without departing from the present invention.

1. A method for digital emulation of cash-based transactions wherein upon a server receiving a request for digital currency for a nominated amount, the server generates and sends a unique link, the unique link comprising one of: a short URL, URL, unique web address, and unique identifier; and wherein the unique link has attached to it at least one selected from the group comprising: image(s), picture(s), video, audio, document(s), advertisement(s), check-in functionality, geo-tag location(s), and metadata.

2. A method as claimed in claim 1, wherein the advertisement contains a further link able to be accepted by a click on the advertisement.

3. A method as claimed in claim 2, wherein the further link contains a value determined by the advertiser.

4. A method as claimed in claim 3, wherein, the value is at least one selected from the group consisting of: actual currency, the advertiser's brand “currency”, a discount voucher or token, a promotion value based on a percentage of the total cost, a discounted gift, a free gift; a reimbursement, and other forms of physical items.

5. A method as claimed in claim 2, wherein the further link is mass distributed and the value is based on the individual's account name or identifier.

6. A method as claimed in claim 6, wherein an account to where the value is credited and/or sent is also based on the individual's account name or identifier.

7. A method as claimed in claim 1, wherein the unique link further comprises at least one serial number of digital currency.

8. A method as claimed in claim 7, wherein the unique link is a link to a value in an associated currency value.

9. A method as claimed in claim 7, wherein the request originates from apparatus used or controlled by a user.

10. A method as claimed in claim 7, wherein the unique link is associated to detailed encrypted data contained in a database for a payment transaction or a currency denomination.

11. A method as claimed in claim 7, wherein the unique link includes a domain of a country concerned.

12. A method as claimed in claim 7, wherein the unique link is secure.

13. A method as claimed in claim 7, wherein the unique link is encrypted.

14. A method as claimed in claim 7, wherein the unique link follows a currency denomination of currency of a monetary authority.

15. A method as claimed in claim 14, where the server creates the unique links based on any denomination or combination of denominations of the digital currency.

16. A method as claimed in claim 7, wherein the at least one serial number is related to that of an actual bank note.

17. A method as claimed in claim 7, wherein the at least one serial number is an artificially created code representing the serial number of a bank note for that denomination in that country, if one were to be physically created.

18. A method as claimed in claim 16, wherein the monetary authority reserves a series of serial numbers of bank notes of a particular denomination in actual, physical circulation, and a different series of serial numbers of digital currency in circulation in the digital domain.

19. A method as claimed in claim 7, wherein the short URL, URL, unique web address, and unique identifier comprises a domain name being the domain name of the relevant issuing authority, card company, or server.
